(19) United States
(12) Patent Application Publication
(10) Pub. No.: US 2026/0157259 A1
(43) Pub. Date: Jun. 11, 2026

(54) AUTOMATED TRANSITIONS IN WORK MACHINE OPERATION DURING END-OF-PASS TURNS

(71) Applicant: Deere & Company, Moline, IL (US)

(72) Inventor: AARON G. VESPERMAN, Ankeny, IA (US)

(21) Appl. No.: 18/976,578

(22) Filed: Dec. 11, 2024

(51) Int. Cl. A01B 69/04

(52) U.S. Cl. CPC A01B 69/008

(57) ABSTRACT

A computer-implemented system and method are provided for planning and automating execution of end-of-pass turns by self-propelled work machines operating within defined work areas, coverage of which requires multiple work machine passes. Algorithms and/or models are generated and trained based on inputs corresponding to at least work machine operating parameters and further correlated with specified turn outcomes. In a current operation and for a current pass by the work machine, an operating envelope is calculated for an upcoming end-of-pass turn by reference to the algorithms and/or models and in view of current inputs corresponding to at least operating parameters of the work machine, including a steady state advance speed thereof. At least the advance speed is automatically controlled during the end-of-pass turn based on the calculated operating envelope, and upon initiating a subsequent pass by the work machine, the advance speed is being returned to the steady state advance speed.

### FIELD OF THE DISCLOSURE

The present disclosure relates generally to work machines, such as for example agricultural work machines operating in multiple passes across a defined work area, and more particularly to automated systems and methods for determining and orchestrating operating envelope transitions during end-of-pass turns.

### BACKGROUND

Work machines as discussed herein may generally but without limitation comprise agricultural machines, including sprayers, combine harvesters, tractors, mowers, conditioners, or the like. It may be understood that a work machine as disclosed herein may include integrated equipment for working or treating the area being traversed, or that the work machine may comprise a tractor or equivalent vehicle having an attachment configured to perform the working or treating of the area being traversed.

It may further be understood that systems, methods, and associated concepts according to the present disclosure may be utilized for other types of work machines, such as construction vehicles, forestry vehicles, and the like, unless otherwise specifically stated and for example in the context of structural or functional elements expressly distinguishing among the various types of applications.

Referring to the sprayer example, such work machines typically need to minimize changes in advance speed and travel distance in the headland turn rows, while also maintaining consistent application speed when the boom crosses the headland boundary, wherein an optimal spray rate is utilized to avoid overapplied and underapplied product. For example, premature deceleration prior to crossing the boundary into the headland may result in overapplied product with respect to a portion of the work area, whereas late acceleration to the steady-state advance speed upon crossing the boundary from the headland may result in underapplied product with respect to a corresponding portion of the work area.

Prior efforts to optimize turns have produced unacceptable lateral errors, for example with respect to headland exits when advance speeds have not been reduced and resumed with appropriate timing during the turn. Prior efforts also tend to properly account in many contexts for the negative impacts of soil type and weight transfer (load transfer in wheeled vehicle dynamics) on, for example, lateral slip or steering slip angle, in the absence of a perfectly timed longitudinal deceleration in the initial turn.

### BRIEF SUMMARY OF THE DISCLOSURE

The current disclosure provides an enhancement to conventional systems and methods, as one example and in the context of sprayers by automatically synchronizing the work machine speed deceleration with the steering path to minimize steering slip angle and complete turns with low lateral error when crossing a headland boundary.

Deceleration in turn transfers weight load to front wheels, increasing traction and grip of steering wheels for reducing understeer. Systems as disclosed herein may utilize detected, commanded, or otherwise determined end-of-pass turn curvature to trigger automatic vehicle speed deceleration, for example via the drivetrain controller on the work machine. An operating envelope of parameters including the target advance speed during an upcoming turn and corresponding deceleration may for example be calculated based on the current (steady state) speed and the path curvature.

In an embodiment, a computer-implemented method is disclosed herein for planning and automating execution of at least end-of-pass turns by a self-propelled work machine operating within a defined work area, wherein the work area is defined at least in part by one or more boundaries traversable by the work machine, and coverage of the defined work area requires a plurality of passes by the work machine. One or more algorithms and/or models are generated and trained over time based on inputs corresponding to at least work machine operating parameters and further correlated with one or more specified turn outcomes. The trained algorithms and/or models may for example be stored on data storage associated with the work machine for use during a current operation and for a current pass by the work machine, wherein an operating envelope for an upcoming end-of-pass turn is calculated by reference to the one or more algorithms and/or models and in view of one or more current inputs corresponding to at least operating parameters of the work machine, wherein the one or more current inputs comprises a steady state (i.e., during a pass, for example throughout a straight pass) advance speed of the work machine. At least the advance speed of the work machine is automatically controlled during the end-of-pass turn based on the calculated operating envelope, and upon initiating a subsequent pass by the work machine, the advance speed of the work machine is returned to the steady state advance speed.

In one exemplary aspect according to the above-referenced method embodiment, one or more work machines operating parameters and/or ground conditions may be determined during at least a first pass and a first end-of-pass turn of the current operation, and an operating envelope for at least one subsequent end-of-pass turn of the current operation may be calculated based in part on the one or more work machine operating parameters and/or ground conditions determined during the first pass and first end-of-pass turn of the current operation.

In other exemplary aspects according to the above-referenced method embodiment, at least one of the one or more work machine operating parameters and/or ground conditions may be determined during the at least first pass and first end-of-pass turn of the current operation using signals from one or more perception sensors associated with the work machine and having a field of view comprising a turn area traversed during the first end-of-pass turn, and/or signals from one or more machine operation sensors associated with the work machine and corresponding to changes in the advance speed and/or orientation of the work machine during the first end-of-pass turn, and/or signals from one or more position sensors associated with a work implement of the work machine.

In another exemplary aspect according to the above-referenced method embodiment, the end-of-pass turn and the calculated operating envelope may be executed upon or after crossing an associated one of the one or more boundaries to exit the defined work area.

In another exemplary aspect according to the above-referenced method embodiment, the advance speed of the work machine may be returned to the steady state advance speed upon or prior to crossing the associated one of the one or more boundaries to reenter the defined work area.

In either or both of the preceding exemplary aspects, the respective crossings of the associated one of the one or more boundaries may be determined with respect to a work implement associated with the work machine.

In another exemplary aspect according to the above-referenced method embodiment, the calculated operating envelope for each end-of-pass turn may comprise a maximum advance speed at a center point thereof, and/or deceleration from the steady state advance speed prior to initiation of a change in steering angle.

In another exemplary aspect according to the above-referenced method embodiment, at least one of the one or more specified outcomes may comprise a weight transfer during the end-of-pass turn, and the operating envelope for each end-of-pass turn is calculated to effect a target weight transfer.

In another exemplary aspect according to the above-referenced method embodiment, the target weight transfer may be based at least in part on a type of work machine, and/or a current load.

In another exemplary aspect according to the above-referenced method embodiment, the calculated operating envelope for a current end-of-pass turn may be dynamically adjusted to account for determined changes in heading and/or trajectory relative to respective expected values thereof.

In another embodiment as disclosed herein, a system may be provided for planning and automating execution of at least end-of-pass turns by a self-propelled work machine operating within a defined work area, wherein the work area is defined at least in part by one or more boundaries traversable by the work machine, and coverage of the defined work area requires a plurality of passes by the work machine. The system comprises data storage having stored thereon one or more algorithms and/or models trained based on inputs corresponding to at least work machine operating parameters and further correlated with one or more specified turn outcomes, and one or more processors functionally linked to the data storage and to one or more sensors associated with the work machine. The one or more processors are configured to direct the performance of steps according to the above-referenced method embodiment and optionally one or more of the subsequently recited exemplary aspects thereof.

The data storage including the algorithms and/or models may for example reside on the work machine and accessible by a controller during the operation in the defined work area.

The algorithms and/or models may in some embodiments be generated and trained in a remote computing environment, for example in a cloud computing environment, and downloaded to data storage on the work machine for use during the operation in the defined work area. The algorithms and/or models may optionally in some embodiments be stored in the cloud computing environment and retrievable by one or more processors residing on the work machine during operation in the defined work area.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a perspective view of an exemplary embodiment of a work machine according to the present disclosure.

FIG. 2 is a block diagram representing an exemplary embodiment of a control system for a work machine of the present disclosure.

FIG. 3 is a flowchart representing an exemplary embodiment of a method according to the present disclosure.

FIGS. 4A and 4B are graphical diagrams representing an example of an executed operating envelope during an end-of-pass turn by a work machine according to the present disclosure.

FIGS. 5A-5D are graphical diagrams representing another example of an executed operating envelope during an end-of-pass turn by a work machine according to the present disclosure.

### DETAILED DESCRIPTION

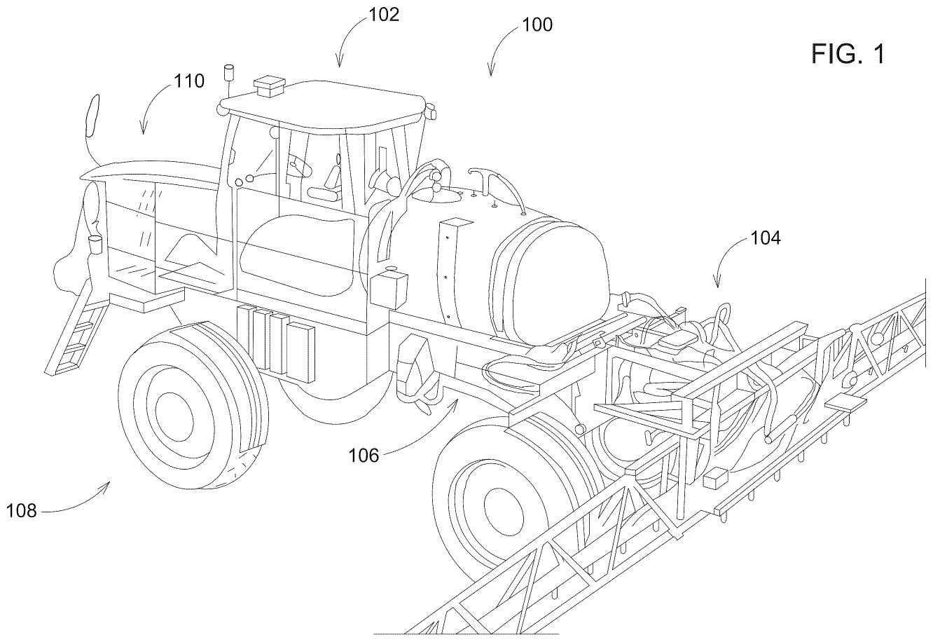

Referring now to the drawings and particularly to FIG. 1, a representative work machine is generally designated by the number 100 and may be briefly described herein. In an embodiment as shown, the work machine 100 may be a sprayer or spraying machine including a vehicle 102 which supports, drives, or otherwise tows a work implement 104. The work implement 104 in this context may be or otherwise carry an on-board spraying system, wherein liquid may be applied to a work area (field) being traversed during operation of the work machine. A tank containing the liquid may be fluidically coupled to spray nozzles associated with the work implement 104 by a delivery system comprising a set of conduits. A fluid pump is configured to pump the liquid from the tank through the conduits through the spray nozzles, which are coupled to, and spaced apart along, a boom. The boom includes arms which can articulate or pivot relative to a center frame 106. In various embodiments, the arms may be movable between, e.g., a storage or transport position and an extended or deployed position.

While a sprayer is illustrated and further described herein as an exemplary work machine 100, it may be appreciated that various alternative types of work machines are within the scope of the present disclosure unless otherwise specifically noted. For example, and without implied limitation, other types of such work machines may include other agricultural machines such as combine harvesters, planters, tractors, and the like, earth-working construction machines, forestry machines, etc.

In the example illustrated in FIG. 1, the work machine 100 includes a self-propelled vehicle 102 having an operator compartment, ground-engaging units 108 (e.g., wheels or other traction elements), and a propulsion system 110 (e.g., internal combustion engine).

As used herein, directions with regard to work machine 100 may be referred to from the perspective of an operator seated thereon; the left of work machine 100 is to the left of such an operator, the right of work machine is to the right of such an operator, the front or fore of work machine is the direction such an operator faces, the rear or aft of work machine is behind such an operator, the top of work machine is above such an operator, and the bottom of work machine below such an operator.

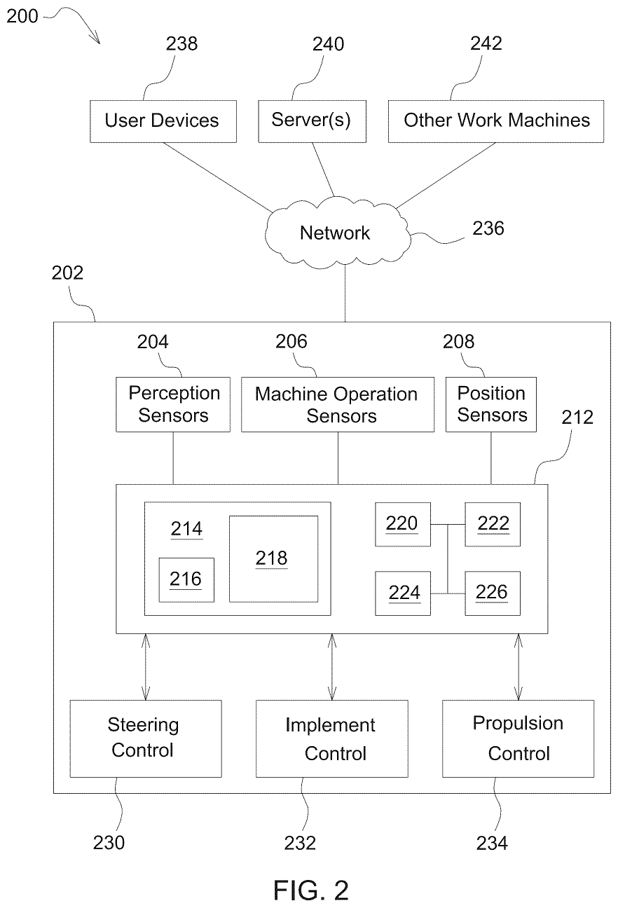

A user interface 214 (further represented in FIG. 2) may be located proximate to the operator seat for use by an operator of the work machine 100. The user interface 214 may include or otherwise be functionally linked to one or more corresponding user interface tools 216 for input and/or output with respect to a controller 212 as further described below. Such user interface tools may for example include a plurality of user selectable touch buttons (e.g., soft buttons), to select from a plurality of commands or menus, each of which may be selectable through a touch screen having a display unit 218. Touch buttons respond to touch and do not include a mechanical component requiring a force sufficient to engage mechanical features. The touch screen may be a graphical user interface configured to display icons as well as content of work machine applications. The display unit 218 may be configured to display in the touch screen still images, moving images, and video content through one or more different types of displays. The display unit 218 may include, but is not limited, to cathode ray tube (CRT) displays, light-emitting diode (LED) displays, and liquid crystal displays (LCD).

Another form of user interface (not shown) may take the form of a display unit that is generated on a mobile (i.e., carried by the operator) or remote (i.e., not onboard) computing device 238, which may display outputs such as status indications and/or otherwise enable user interaction such as the providing of inputs to the system. In the context of a remote user interface, data transmission between for example the machine control system 202 and the remote user interface may take the form of a wireless communications system and associated components as are conventionally known in the art.

The work machine 100 may further include operator-accessible interface tools such as a joystick, accelerator pedal, hand lever, or the like which enables the operator to adjust the speed of the vehicle. Other exemplary tools accessible from the operator seat may include a steering wheel, a plurality of operator selectable touch buttons configured to enable the operator to control the operation and function of the work machine 100, and any accessories or implements associated with the work machine.

As schematically illustrated in FIG. 2, an embodiment of a system 200 as disclosed herein includes a control system 202 associated with a work machine 100, in functional communication via a communications network 236 with remote user computing devices 238, cloud servers 240, other work machines 242, and the like. An exemplary control system 202 as illustrated includes a controller 212, which may be part of an overall work machine control unit, or it may be a separate control module.

The controller 212 is configured to receive input signals from one or more sensors 204, 206, 208 or equivalent input data sources.

Perception sensors 204 may generate output signals or otherwise capture images in a field of view which represents the surroundings of the work machine 100. Exemplary perception inputs may be provided using ultrasonic sensors, laser scanners, radar wave transmitters and receivers, imaging devices, structured light sensors, thermal sensors, and other optical sensors, wherein exemplary imaging devices may include a digital (CCD/CMOS) camera, an infrared camera, a stereoscopic camera, a /me-of-flight/ depth sensing camera, high resolution light detection and ranging (LiDAR) scanners, radar detectors, laser scanners, and the like within the scope of the present disclosure.

Machine operation sensors 206 may generate output signals which directly represent the work machine condition or operation. For example, advance speed, steering angle, vehicle orientation, angular velocity, and/or the like may be directly sensed using appropriate sensors in various embodiments. Advance speed may for example be sensed directly using a speedometer or the equivalent, or alternatively may be detected by sensing a commanded advance speed. Other examples of sensors or equivalent data sources may provide outputs from which relevant work machine conditions or operations may be derived, calculated, or otherwise determined. Steering angle may for example correspond to a sensed position of a user interface tool such as joystick associated with the operator area of the work machine.

Position sensors 208 may be configured to provide location data for the work machine 100 using any of various known techniques, for example including global navigation system sensors (GNSS). Location data may also relate to the relative positioning of a work implement 104 assembly with respect to a main frame 106 of a work vehicle 102.

The controller 212 of the work machine 100 may be configured to produce outputs to a user interface 214 associated with a display unit 218 for display to the human operator. The controller 212 may be configured to receive inputs from the user interface 218, such as user input provided via the user interface 218. Not specifically represented in FIG. 2, the controller 212 of the work machine 100 may in some embodiments further receive inputs from and generate outputs to remote devices 238 associated with a user via a respective user interface, for example a display unit with touchscreen interface. Data transmission between for example the control system 200 and a remote user interface may take the form of a wireless communications network 236 and associated components as are conventionally known in the art.

In an embodiment, a remote server 240 such as in the form of a cloud server environment may include one or more processors functionally linked with the control system 200. In certain embodiments, a mobile or remote user interface, and/or the work machine control system 200, may be further coordinated or otherwise interact with the remote server 240 or other computing device 238 for the performance of certain operations in a system as disclosed herein. In one embodiment, for example, model development may be performed in a cloud server environment based on inputs received from a work machine, wherein validated models are downloaded to the work machine for use by the controller in a given operation or otherwise in certain embodiments accessible by the controller from the server during operation.

The controller 212 may be configured to generate control signals for controlling the operation of respective actuators, or signals for indirect control via intermediate control units, associated with a work machine steering control unit 230, an implement control unit 232, and/or a propulsion control unit 234. The controller 212 may for example be electrically coupled to respective components of these and/or other systems by a wiring harness such that messages, commands, and electrical power may be transmitted between the controller 212 and the remainder of the work machine 100.

For example, control signals may comprise a steering control signal or data message that defines a steering angle of the steering shaft, a braking control signal or data message that defines the amount of deceleration, hydraulic pressure, or braking friction to the applied to brakes, a propulsion control signal or data message that controls a throttle setting, a fuel flow, a fuel injection system, vehicular speed or vehicular acceleration. Further, where the work machine 100 may be propelled by an electric drive or electric motor, the propulsion control signal may control or modulate electrical energy, electrical current, electrical voltage provided to an electric drive or motor. The control signals generally vary with time as necessary to track the path plan. The lines that interconnect the components of the system may comprise logical communication paths, physical communication paths, or both. Logical communication paths may comprise communications or links between software modules, instructions, or data, whereas physical communication paths may comprise transmission lines, data buses, or communication channels, to name non-limiting examples.

The steering control unit 230 may comprise or otherwise interact with an electrically controlled hydraulic steering system, an electrically driven rack and pinion steering, an Ackerman steering system, or another steering system. The propulsion control unit 234 may comprise or otherwise interact with an internal combustion engine, an internal combustion engine-electric hybrid system, an electric drive system, or the like.

It may be understood that the controller 212 described herein may be a single controller having all of the described functionality, or it may include multiple controllers wherein the described functionality is distributed among the multiple controllers.

Various operations, steps or algorithms as described in connection with the controller 212 can be embodied directly in hardware, in a computer program product such as a software module executed by a processor 220, or in a combination of the two. The computer program product can reside in RAM memory, flash memory, ROM memory, EPROM memory, EEPROM memory, registers, hard disk, a removable disk, or any other form of computer-readable medium 222 or equivalent data storage as known in the art. An exemplary computer-readable medium can be coupled to the processor such that the processor can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” 220 as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

A communication unit 224 may support or provide communications between the controller 212 and external systems or devices, and/or support or provide communication interface with respect to internal components of the work machine 100. The communications unit may include wireless communication system components (e.g., via cellular modem, WiFi, Bluetooth or the like) and/or may include one or more wired communications terminals such as universal serial bus ports.

Data storage 226 of the control system 202 as discussed herein may, unless otherwise stated, generally encompass hardware such as volatile or non-volatile storage devices, drives, memory, or other storage media, as well as one or more databases residing thereon.

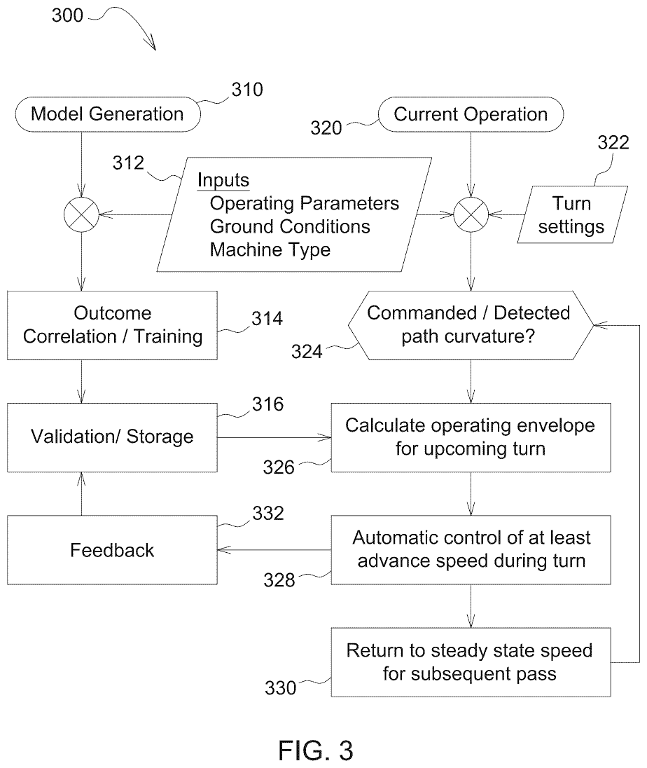

Referring next to FIG. 3, the depicted flowchart represents an embodiment of a method 300 for operating a work machine 100, and more particularly an exemplary adaptive control of parameters such as advance speed through end-of-pass turns as disclosed herein. While the illustrated embodiment may include a specific arrangement of steps, inputs, outputs, and the like, it may be understood that certain steps may be combined, performed in a different order, or even omitted altogether in other embodiments within the scope of the present disclosure, unless otherwise specifically noted herein.

The term “end-of-pass turn” as used herein may generally relate to turns of a work machine from a first (current) pass across a work area to a second (subsequent) pass across a work area, wherein the current and subsequent passes may in some examples be parallel and adjacent, or may be parallel and non-adjacent, or may not be in parallel at all depending on the context.

One example of a work machine operation may require consecutive and adjacent passes back and forth across the work area, each pass starting and ending approximately at a passable headland boundary with the end-of-pass turn taking place in the headland area.

Another example of a work machine operation may require multiple parallel but non-adjacent passes back and forth across the work area, wherein the work machine may double back to complete the “adjacent” pass areas, each end-of-pass turn again taking place in the headland area.

Yet another example of a work machine operation may involve multiple passes within a work area for ditching/drainage purposes, wherein the passes are often neither parallel nor adjacent, and an end-of-pass turn may simply be defined as the trajectory/path connecting the end of a first pass and the beginning of a second pass.

Yet another example of a work machine operation may involve a continuous path, for example about a perimeter or otherwise defining a headland area or boundary, wherein relatively straight “passes” along the route are accompanied by intervening end-of-pass turns for which calculated and executed operating envelopes are optimal to avoid operating faults or otherwise to enhance operator comfort.

The method 300 may generally relate to determining and implementing an operating envelope with respect to a current operation 320 of a work machine 100, but it may be understood that various steps of the current operation overlap with steps associated with a corresponding model generation and development process 310, as for example inputs provided in step 312 may be provided for iterative development and potential improvement of the models, prior to or otherwise while in the context of the current operation.

Exemplary and non-limiting inputs according to step 312 may include reception, collection, calculation, or otherwise obtaining of inputs corresponding to operating parameters, ground conditions, a machine type, and the like. Such operating parameters may include for example vehicle orientation, advance speed, engine utilization/load, steering angle, wheel slip, roll, and the like. The inputs may be understood as representing actual and substantially real-time values, wherein “substantially real-time” may typically indicate the values are as close to real-time as possible while accounting for some inherent delays in sensing, converting, transmitting, or otherwise indicating to the respective values to the controller during the work machine operation.

Some or all of the obtained inputs corresponding to actual and real-time machine operating values may be compared to corresponding initial operation settings to determine the need for responsive action such as for example control signals or other forms of intervention. Specifically, various embodiments of a method 300 as disclosed herein determine a steering angle (or turning angle) of the work machine, and directly control at least an advance speed of the work machine based on at least a turn state derived from the steering angle.

In an embodiment of the method 300 including a model generation and/or development stage 310, inputs from 312 may be received, compiled, aggregated, etc., over time as input data sets and correlated with one or more observed outcomes relating to end-of-pass turns for training of one or more selectively retrievable learning models and/or algorithms.

The model generation stage 310 may further include validation and storage of the models in 316, having been sufficiently developed over time using “test” input data sets and corresponding observed outcomes, for example including feedback 332 from a “current” data set, such that they may be retrieved and utilized during subsequent operations for estimation and/or prediction based on subsequent operations and corresponding data sets.

In some embodiments, the models may include neural network-based models having variable governing parameters which are optimized during training to better simulate (or approximate in a particular simulation) observed real-life results corresponding to an input data set. Such parameters may initially be set (e.g., user-specified) before training. Tuning of the hyperparameters, or in other words optimizing the values therefor, may follow during training to obtain a set of values for the parameters corresponding to an accurate input-output mapping of the neural network for the training data set. In various embodiments, tuning of parameters may be performed automatically during or between training iterations, manually based on user selection via a user interface, or combinations thereof. In some embodiments the parameters are not initially user-specified but instead predetermined formulaically or otherwise according to a “best guess” distribution of possible simulation parameters, and in some embodiments may initially be unknown and merely derived during training. The parameters may for example determine aspects of the neural network structure and/or training parameters, such as the number of hidden neuron layers, number and/or definition of training steps, learning rates, batch size, and the like.

Turning now to a stage of the method 300 corresponding to a current operation 320, step 322 as depicted relates to determining or otherwise obtaining end-of-pass turn settings for the operation in question. In an embodiment, turn settings may correspond to a configuration of the work machine and the type of task to be performed. Turn settings may in some cases be specified via user input, for example by manual selection from among various options associated with a user interface. Turn settings in an embodiment may alternatively be specified based on a detected configuration of the work machine, for example attachments thereto, wherein spraying operations may inherently require different settings than planting or harvesting operations, and work machines of varying loads and work implements of varying widths may require different respective settings as well even for equivalent operations. In an embodiment, the method may include provisionally determining turn settings for the work machine upon startup and prompting the operator to confirm or otherwise modify the turn settings via the user interface.

Turn settings may correspond to other inputs as noted above with respect to step 312, such as for example a steady state (i.e., straight path) advance speed of the work machine, different job execution plans, ground conditions in the work area and more particularly in the headland or the area proximate thereto, and the like. For example, turn settings with respect to one operation may require different speeds (e.g., a maximum speed at a center point of the turn, or a maximum range between the steady state advance speed and the minimum speed during the turn) than an equivalent operation, based on an amount of headland area available, the risks of damage to be done to the work area or the work machine in view of work area characteristics, characteristics of one or more peripheral/boundary regions of the work area which may be traversed but require specific operation settings, etc.

The method 300 may proceed in association with the current operation 320, further for example in view of the inputs 312, turn settings 322, and optionally upon determining a commanded and/or detected path curvature (step 324), by calculating an operating envelope for an upcoming end-of-pass turn (step 326).

In some embodiments, step 324 may be omitted, for example where an upcoming end-of-pass turn and timing thereof is predicted based on determined locations and movement of the work machine relative to known parameters in a work area map or work plan.

In some embodiments, an upcoming end-of-pass turn and corresponding prompt for calculation of an operating envelope may be manually triggered, for example through user input received via an associated user interface tool.

In other embodiments, however, the upcoming end-of-pass turn may be determined in step 324 by monitoring actual operating parameters of the work machine and/or associated commands. For example, an upcoming end-of-pass turn may be triggered automatically upon detecting a change in steering angle corresponding to a turn (e.g., greater than a threshold amount of change in steering angle or for greater than a threshold period of time), or upon receiving operator commands to the steering control unit which correspond to such a change in steering angle.

Calculation of an operating envelope in step 326 may include calculating one or more target values for operating parameters, for example relating to or otherwise defining an optimal trajectory and/or associated speed/acceleration components for physics-based feed forward control of the work machine, throughout various portions of the end-of-pass turn. In an embodiment, known inputs relating to mass estimations, center-of-gravity, and axle loads based on a type of work machine, among others, may be used to calculate an optimized deceleration to maintain a balanced 50/50 load transfer with respect to front-wheel axles and to maximize grip while minimizing soil compaction, as one example of a target outcome.

In an embodiment, a speed value or maximum speed value, and a maximum deceleration limit for maintaining downward force on the front steering wheels, may be determined based on a sensed degree of the turn, as opposed to values which are applied for any detected turns greater than a threshold sensitivity relative to the baseline straight-path steering angle. For example, a sharp turn corresponding to the end of a row and turning around of the work machine may be treated differently than a short and transient turn relating, e.g., to navigation about an object within an otherwise continuing path, with respect to the desired changes to cruise speed settings.

As previously noted, the operating envelope may be calculated by reference to one or more models and/or algorithms developed for correlating input data sets for some or all of the operation settings to desired or unfavorable outcomes associated with the end-of-pass turn for a type of machine or operation, such as for example over- or under-application of product by the work machine, lateral error which may for example correspond with involuntary movement of the work machine from a desired trajectory or path, damage to the ground surface for example relating to wheel slip or soil compaction, or the like.

In an embodiment, the method 300 may require manual operation throughout a first end-of-turn pass, or may perform an automated operation based upon a predetermined operating envelope, wherein an operating envelope is calculated for the subsequent end-of-turn passes based on observed operating parameters and/or ground conditions during the initial pass and end-of-pass turn. Such an embodiment may for example allow the system to validate that the work machine is executing turns in accordance with expected operating conditions, or otherwise to make adjustments for optimizing the operating envelope for subsequent turns.

Determining and executing an operating envelope for various end-of-turn passes subsequent to the first end-of-turn pass may include determining work machine operating parameters, ground conditions, and/or the like during at least the first pass and first end-of-pass turn of the current operation.

Such a determination may be made in an embodiment using signals from one or more perception sensors 204 associated with the work machine 100, for example having a field of view comprising a turn area traversed during the first end-of-pass turn. The inputs derived from such signals may be used to determine, for example, ground conditions such as slope, moisture, or the like.

Alternatively, or in addition, such a determination may be made using signals from one or more machine operation sensors 206 associated with the work machine 100 and corresponding to changes in the advance speed and/or orientation of the work machine during the first end-of-pass turn.

Alternatively, or in addition, such a determination may be made using signals from one or more position sensors 208 associated with a work implement 104 of the work machine 100. For example, if the boom is raised or lowered the resulting impact on one or more turn characteristics may be ascertained and accounted for during subsequent turns having the work implement in a similar position.

The end-of-pass turn and the calculated operating envelope may for example be executed upon or after crossing a defined headland boundary or other defined exits of the defined work area, for example in view of turn settings having been specified in step 322. In this manner, the problem of overapplied product within the defined work area may be avoided or at least mitigated.

In an embodiment, end-of-pass turn and the calculated operating envelope may for example be completed, wherein the advance speed of the work machine is returned to the steady state advance speed (or a determined adjustment thereto) upon or prior to re-crossing the defined headland boundary or other defined exits of the defined work area, again for example in view of turn settings having been specified in step 322. In this manner, the problem of underapplied product within the defined work area may be avoided or at least mitigated.

In an embodiment, the crossing and/or recrossing of the specified boundary may be determined in view of a work implement associated with the work machine, rather than for example an initial crossing associated with a front end of the work machine as a whole, or a total crossing associated with a rear end of the work machine as a whole. The crossing of the specified boundary by the work implement may for example relate to a specified axis associated with the work implement (e.g., boom) and transverse to a longitudinal axis corresponding to a forward direction of the work machine. The specified axis may for example be defined with respect to a center of the work implement, or may alternatively be defined to encompass a ground-engaging or treatment area associated with the work implement.

The method 300 may continue in step 328 with automatic control of one or more machine operating parameters and associated control units/actuators to execute the calculated operating envelope through the end-of-pass turn in question.

The method 300 may continue in step 330 by returning to a steady state advance speed for a subsequent pass across the work area. The steady state advance speed may for example be the same speed which is predetermined for each straight pass across the field, or may be adjusted manually by the operator or automatically in view of conditions. Observed conditions which may impact the steady state advance speed in subsequent passes may for example include slippage, lateral error, or the like as relate at least in part to excessive advance speed upon initial crossing of a headland boundary, for example in view of transient ground conditions.

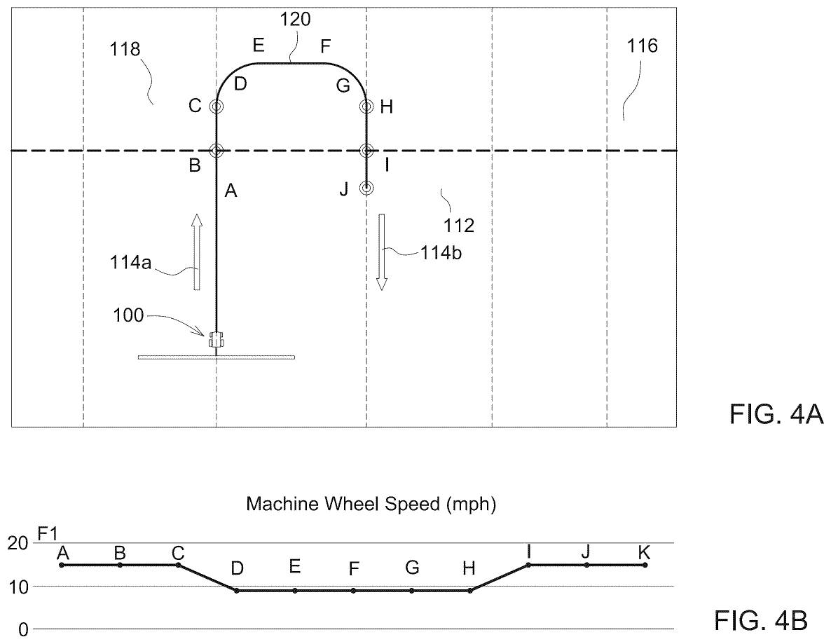

Referring now and for illustrative purposes to FIGS. 4A and 4B, an exemplary operation may be described with respect to at least portions of the method 300. A work machine 100 is represented as proceeding along a current pass 114a through a work area 112. As the work machine reaches point A along the current pass 114a and approaches a crossing of the headland boundary 116 at point B, the advance speed F1 of the work machine 100 remains at a steady state value (e.g., about 15 mph).

In the illustrated example, the work machine 100 continues traveling straight along the current pass 114a at least initially upon crossing the headland boundary 116 and into the headland area 118, and the advance speed F1 is maintained at the steady state value during this time between point B and point C.

In other exemplary operations, however, and for example in view of alterative turn settings, the steering angle may be adjusted to initiate a turn sooner after the initial crossing of the headland boundary, or even immediately upon the initial crossing.

Once an end-of-pass turn 120 begins at point C, or in other words the steering angle is detected or commanded from a straight trajectory associated with the current pass 114a, deceleration of the advance speed is executed in accordance with a calculated operating envelope, wherein for example a feasible advance speed trajectory to achieve a second speed (e.g., a target setpoint) at point D with minimal lateral error may require limiting deceleration when approaching the turn at higher first (e.g., steady state) speeds at point C.

In the illustrated example, this second speed is a minimum speed which is consistently applied during the turn from point D through points E, F, G, and up to point H, wherein the steering angle is returned to a straight trajectory associated with a subsequent pass 114b, and the advance speed is increased from point H up to the steady state advance speed at point I.

In other embodiments, however, it may be appreciated that decreasing of the advance speed from C may continue beyond the points represented as D and/or E, and optionally to a center point (not shown) of the end-of-pass turn 120.

In the illustrated example, the advance speed is increased between points H and I from the minimum speed associated with the end-of-pass turn 120 to the steady state advance speed associated with the subsequent pass 114b, and the steady state advance speed is thereby obtained before the recrossing of the headland boundary 116 and maintained through points (e.g., J) associated with the subsequent pass 114b and preferably until the next end-of-pass turn.

In other embodiments, the increase in advance speed may initiate from the above-referenced center point or from other points (e.g., F, G) between such a center point and the point H representing a return of the steering angle to a straight trajectory associated with the subsequent pass 114b.

In accordance with the example provided in FIGS. 4A and 4B, a work machine 100 such as a sprayer may automatically synchronize work machine advance speed deceleration and re-acceleration with a steering path throughout an end-of-turn pass to minimize steering slip angle and preferably maintain a consistent product application speed to avoid or at least substantially mitigate overapplication of product prior to the work implement (e.g., boom) crossing the headland boundary 116 and underapplication of product after the work implement recrosses the headland boundary 116.

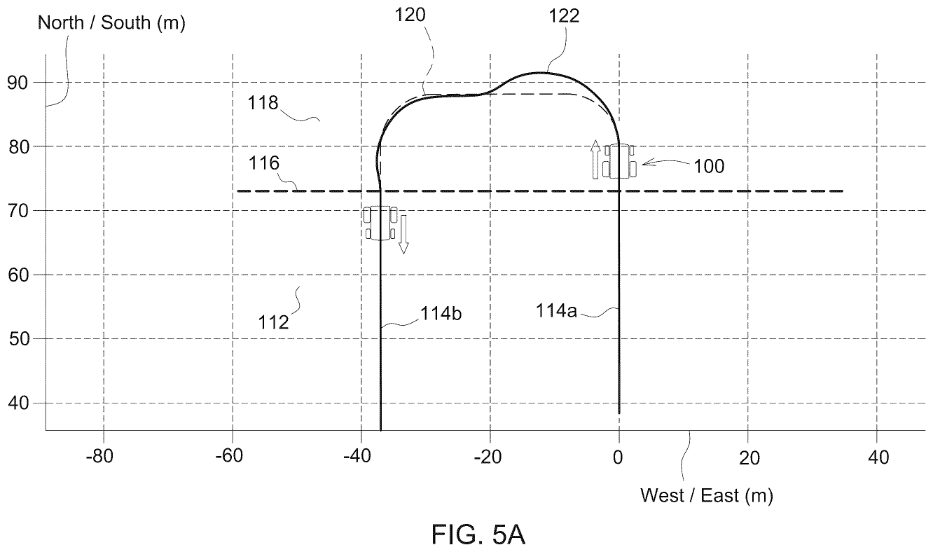

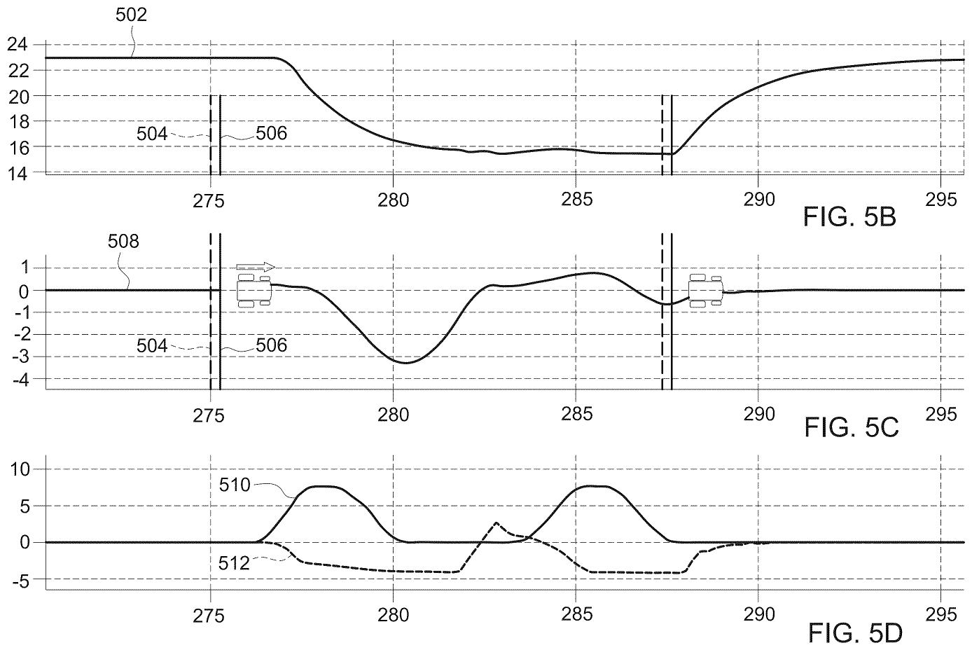

Another example may next be described by reference to FIGS. 5A-5D. In this embodiment, an executed end-of-pass turn 120 between or otherwise bridging a current pass 114a and a subsequent pass 114b across a work area 112 is not necessarily synchronous from start to end, but may for example be planned to allow for the highest possible entry speed and turn while maintaining a target spray rate and avoiding lateral error upon recrossing of the headland boundary 116. A trajectory for an actual end-of-pass turn 122 differs from a projected end-of-pass turn 120 in that the work machine 100 maintains a first speed (e.g., 23 kph) as it crosses the headland boundary 116 (504 in FIG. 5B) and follows an extended curvature before decelerating to a minimum speed (e.g., 15kph) prior to exiting the headland area 118.

In various embodiments, work machine operation settings may be validated or otherwise adjusted to account for predicted outcomes if advance speed is reduced by an expected amount going into a turn. For example, if the work machine is traveling at a relatively high speed which would be substantially reduced into a tight curvature, further in view of a sensed lack of traction, a required amount of time to effectively reduce the speed by the specified amount, or other conditions that could result in negative outcomes with such a sudden change in speed, the work machine operation settings may be proactively adjusted to accommodate such conditions by for example reducing a maximum steady state speed prior to crossing a headland boundary, and/or generally during a subsequent pass.

In FIG. 5B, the advance speed 502 of the work machine is represented as being maintained at a steady state value through the headland boundary 504, and more particularly until after a full crossing of the headland boundary 506, before decelerating to a minimum value (e.g., headland speed) corresponding to the projected or planned end-of-pass turn trajectory 120 and then (in this embodiment) increasing again only after recrossing of the headland boundary, such that the previous steady state value is only reached sometime after recrossing of the headland boundary and travel along the subsequent pass 114b.

In FIGS. 5C and 5D, a lateral error 508 associated with the trajectory of the work machine 100 is represented, primarily in association with the difference between the actual end-of-pass trajectory 122, 512 relative to the projected or planned end-of-pass turn trajectory 120, 510, and correction for which is provided in the latter stage of the end-of-turn pass while still allowing for a highest possible headland/turn entry speed.

In various embodiments, whereas for example deceleration and acceleration functions may be performed automatically during an end-of-pass turn, such functions may be manually overridden by the operator via inputs from appropriate user interface tools (e.g., foot pedal, joystick). In an embodiment, a manual override of the deceleration and acceleration functions may only temporarily remove the automatic implementation of the deceleration and acceleration functions, which otherwise resume when the operator is no longer manually engaging the appropriate user interface tools.

Returning to the method 300 represented in FIG. 3, step 332 as depicted relates to the providing of feedback based on the monitored input parameters and values thereof, further in view of any generated output signals, as part of the model development stage 310 of method 300 for correlation of the input data sets with observed outcomes (favorable or otherwise). Exemplary such observed outcomes may for example be provided manually (for example, via input from the user interface) and/or applied automatically in some embodiments using inputs corresponding or otherwise relevant to the type of outcome.

Thus it is seen that an apparatus and/or methods according to the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments, unless otherwise specifically stated.

What is claimed is:

1. A computer-implemented method of planning and automating execution of at least end-of-pass turns by a self-propelled work machine operating within a defined work area, wherein the work area is defined at least in part by one or more boundaries traversable by the work machine, and coverage of the defined work area requires a plurality of passes by the work machine, the method comprising:
generating and training one or more algorithms and/or models based on inputs corresponding to at least work machine operating parameters and further correlated with one or more specified turn outcomes;
in a current operation and for a current pass by the work machine, calculating an operating envelope for an upcoming end-of-pass turn by reference to the one or more algorithms and/or models and in view of one or more current inputs corresponding to at least operating parameters of the work machine, wherein the one or more current inputs comprises a steady state advance speed of the work machine;
automatically controlling at least the advance speed of the work machine during the end-of-pass turn based on the calculated operating envelope; and
upon initiating a subsequent pass by the work machine, the advance speed of the work machine being returned to the steady state advance speed.

2. The method of claim 1, wherein one or more work machines operating parameters and/or ground conditions are determined during at least a first pass and a first end-of-pass turn of the current operation, and an operating envelope for at least one subsequent end-of-pass turn of the current operation is calculated based in part on the one or more work machine operating parameters and/or ground conditions determined during the at least first pass and first end-of-pass turn of the current operation.

3. The method of claim 2, wherein at least one of the one or more work machine operating parameters and/or ground conditions are determined during the at least first pass and first end-of-pass turn of the current operation using signals from one or more perception sensors associated with the work machine and having a field of view comprising a turn area traversed during the first end-of-pass turn.

4. The method of claim 2, wherein at least one of the one or more work machine operating parameters and/or ground conditions are determined during the at least first pass and first end-of-pass turn of the current operation using signals from one or more machine operation sensors associated with the work machine and corresponding to changes in the advance speed and/or orientation of the work machine during the first end-of-pass turn.

5. The method of claim 2, wherein at least one of the one or more work machine operating parameters and/or ground conditions are determined during the at least first pass and first end-of-pass turn of the current operation using signals from one or more position sensors associated with a work implement of the work machine.

6. The method of claim 1, wherein the end-of-pass turn and the calculated operating envelope are executed upon or after crossing an associated one of the one or more boundaries to exit the defined work area.

7. The method of claim 1, wherein the end-of-pass turn and the calculated operating envelope are executed upon or after crossing of the one or more boundaries by a work implement associated with the work machine.

8. The method of claim 6, wherein the advance speed of the work machine is returned to the steady state advance speed upon or prior to crossing the associated one of the one or more boundaries to reenter the defined work area.

9. The method of claim 8, wherein the advance speed of the work machine is returned to the steady state advance speed upon or prior to crossing of the associated one of the one or more boundaries by a work implement associated with the work machine.

10. The method of claim 1, wherein the calculated operating envelope for each end-of-pass turn comprises a maximum advance speed at a center point thereof.

11. The method of claim 1, wherein the calculated operating envelope for each end-of-pass turn comprises deceleration from the steady state advance speed prior to initiation of a change in steering angle.

12. The method of claim 1, wherein at least one of the one or more specified outcomes comprises a weight transfer during the end-of-pass turn, and the operating envelope for each end-of-pass turn is calculated to effect a target weight transfer.

13. The method of claim 12, wherein the target weight transfer is based at least in part on a type of work machine, and/or a current load.

14. The method of claim 1, wherein the calculated operating envelope for a current end-of-pass turn is dynamically adjusted to account for determined changes in heading and/or trajectory relative to respective expected values thereof.

15. A system for planning and automating execution of at least end-of-pass turns by a self-propelled work machine operating within a defined work area, wherein the work area is defined at least in part by one or more boundaries traversable by the work machine, and coverage of the defined work area requires a plurality of passes by the work machine, the system comprising:
data storage having stored thereon one or more algorithms and/or models trained based on inputs corresponding to at least work machine operating parameters and further correlated with one or more specified turn outcomes; and
one or more processors functionally linked to the data storage and to one or more sensors associated with the work machine, the one or more processors configured to:
in a current operation and for a current pass by the work machine, calculate an operating envelope for an upcoming end-of-pass turn by reference to the one or more algorithms and/or models and in view of one or more current inputs corresponding to at least operating parameters of the work machine and determined at least in part from signals received from the one or more sensors, wherein the one or more current inputs comprises a steady state advance speed of the work machine;
automatically control at least the advance speed of the work machine during the end-of-pass turn based on the calculated operating envelope; and
upon initiating a subsequent pass by the work machine, to return the advance speed of the work machine to the steady state advance speed.

16. The system of claim 15, wherein one or more work machines operating parameters and/or ground conditions are determined during at least a first pass and a first end-of-pass turn of the current operation, and an operating envelope for at least one subsequent end-of-pass turn of the current operation is calculated based in part on the one or more work machine operating parameters and/or ground conditions determined during the at least first pass and first end-of-pass turn of the current operation.

17. The system of claim 16, wherein at least one of the one or more work machine operating parameters and/or ground conditions are determined during the at least first pass and first end-of-pass turn of the current operation using signals from:
one or more perception sensors associated with the work machine and having a field of view comprising a turn area traversed during the first end-of-pass turn;
one or more machine operation sensors associated with the work machine and corresponding to changes in the advance speed and/or orientation of the work machine during the first end-of-pass turn; and/or
one or more position sensors associated with a work implement of the work machine.

18. The system of claim 15, wherein:
the end-of-pass turn and the calculated operating envelope are executed upon or after crossing an associated one of the one or more boundaries to exit the defined work area; and
the advance speed of the work machine is returned to the steady state advance speed upon or prior to crossing the associated one of the one or more boundaries to reenter the defined work area.

19. The system of claim 18, wherein the respective crossings of the associated one of the one or more boundaries are by a work implement associated with the work machine.

20. The system of claim 15, wherein the calculated operating envelope for each end-of-pass turn comprises:
a maximum advance speed at a center point thereof; and
deceleration from the steady state advance speed prior to initiation of a change in steering angle.
